(19) United States
(12) Patent Application Publication
(10) Pub. No.: US 2006/0040555 A1
(43) Pub. Date: Feb. 23, 2006

(54) Electrical connector having structures for preventing deflected-insertion

(75) Inventors: Zhi-Qiang Chen, Kunsan (CN); Xiao-Li Li, Kunsan (CN); Bing Peng, Kunsan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/106,158

(22) Filed: Apr. 13, 2005

(30) Foreign Application Priority Data
Aug. 17, 2004 (CN) 2004200788914

(51) Int. Cl. H01R 13/648

(52) U.S. Cl. 439/607

(57) ABSTRACT

An electrical connector includes an insulative housing (1), a plurality of contacts (2), and a shell (3) surrounding the housing. The insulative housing includes a base portion (10) with a plurality of passageways (111) extending therethrough, a tongue portion (12) extending forwardly from the base portion, and a rib (11) formed at an end of the tongue portion. A plurality of terminals are received in the passageways and extend forwardly for dividing the tongue portion into several parts. Each terminal comprises a conductive surface (22, 23). The rib extends adjacent to one of the terminals and partially protrudes beyond the conductive surface of the one of the terminals.

### BACKGROUD OF THE INVENTION

1. Field of the Invention

The present invention generally relates to an electrical connector, and particularly relates to an electrical connector having structures for preventing deflected insertion of a complementary connector. This invention relates to a contemporaneously filed application titled “ELECTRICAL CONNECTOR HAVING IMPROVED STRUCTURE REGARDING TERMINALS” having the same applicant and the same assignee with the instant application.

2. Description of Related Arts

Due to the booming development of the electronic industry, electro-consumer products become more and more popular. Miniaturization, integration and multi-function have been the inevitable trends what those products develop to. It also desires more power signals to be given to the electrical equipments, in respect that the integrated circuits have more applications, and the densities of the electrical components connected to the integrated circuits become much higher. To obtain more input power, power connectors of the electro-consumer products often need more conductors. U.S. Pat. No. 5,158,471 discloses a power connector having many contacts, which are densely arranged in an insulative housing. However, a bare periphery of those contacts makes them vulnerable, then have poor orientation ability. Therefore, when a complementary connector is inserted into the power connector, nevertheless the insertion direction has just a little deflection, those non-protective contacts would be forced and tend to warp even breaking off, which may result in signals shut off.

U.S. Pat. No. 6,482,045 discloses an improved electrical connector. It has an insulator body with a planar plate-like contact support protruding forwardly. At the front end of the contact support forms outer protrusions, against which front ends of contacts of a complementary connector abut. While insertion of the complementary connector, this connector could avoid damages to contacts resulting from deflected insertion of the complementary connector, because the mating contacts touch upper and lower sides of outer protrusions firstly, which weakens the forces greatly. However, this structure complexes the manufacture of the housing, and does not follow the miniaturization trend of products.

Hence, it is desirable to have an improved electrical connector to overcome the above-mentioned disadvantages of the related art.

### SUMMARY OF THE INVENTION

It is an object of the present invention to provide an electrical connector having structures for preventing deflected insertion of a complementary connector, and with smaller size and more convenient manufacture of the connector.

In order to achieve the above-mentioned object, an electrical connector includes an insulative housing, a plurality of contacts, and a shell surrounding the housing. The insulative housing includes a base portion with a plurality of passageways extending therethrough, a tongue portion extending forwardly from the base portion, and a rib formed at an end of the tongue portion. A plurality of terminals are received in the passageways and extend forwardly for dividing the tongue portion into several parts. Each of the terminals comprises a conductive surface. The rib extends adjacent to one of the terminals and partially protrudes beyond the conductive surface of the one of the terminals.

Other objects, advantages and novel features of the invention will become more apparent from the following detailed description of the present embodiment when taken in conjunction with the accompanying drawings.

### BRIEF DESCRIPTION OF THE DRAWING

FIG. 1 is an exploded, perspective view of an electrical connector in accordance with the present invention;

FIG. 2 is a view similar to FIG. 1, but taken from a different perspective;

FIG. 3 is a partially assembly perspective view of the electrical connector of FIG. 1, wherein the terminals have been mounted in the insulative housing;

FIG. 4 is a perspective view of the electrical connector in accordance with the present invention; and

FIG. 5 is a view similar to FIG. 4, but taken from a different perspective.

### DETAILED DESCRIPTION OF THE PREFERRED EMBODIMENT

Reference will now be made to the drawing figures to describe the present invention in detail.

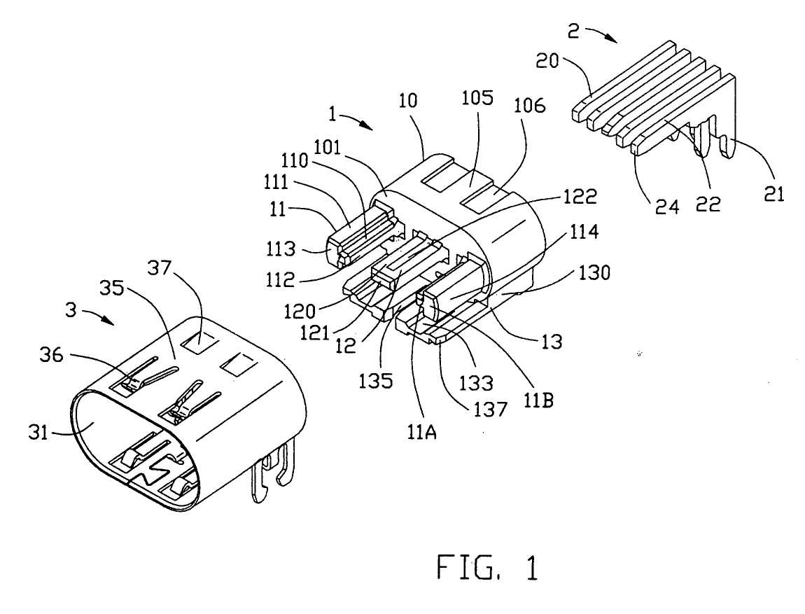

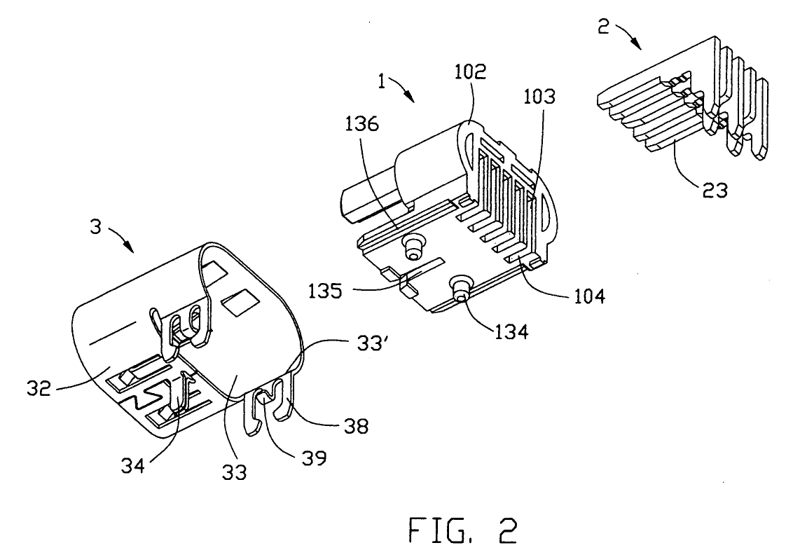

With reference to FIGS. 1-2, an electrical connector in accordance with the present invention comprises an insulative housing 1, a plurality of terminals 2 received in the insulative housing 1 and a shell 3 surrounding the insulative housing 1.

Referring to FIGS. 1-2, the insulative housing 1 has a base portion 10 with an approximately elliptic cross-section. The base portion 10 comprises an upper face 105, a front face 101 and an opposite back face 102. A plurality of receiving passageways 103 extend through the base portion 10 in a front-to-back direction. Several vertical slots 104 are defined by concaved into lower part of the back face 102, and are in communication with corresponding receiving passageways 103 respectively. The upper face 105 of the base portion 10 defines two cutouts 106 at a rear thereof. A longitudinal tongue portion 12 is formed extending forwardly from the middle of the base portion 10. Plural receiving passageways 103 further extend onward to divide the tongue portion 12 into several parts, and these parts lie parallel with each other in a mating direction of a complementary connector (not shown). These parts could be individual with the others, or link with neighboring one at distal ends, even could be cut off absolutely from the base portion 10. In this embodiment, two middle divided parts of the rib 12 are linked by a beam 121 at distal ends with an inside elongated through-hole 122 defined therebetween. The through-hole 122 is in communication with the middle passageway 103. There are also two parts respectively next to the two middle ones been cut off from the base portion 10. Two side ribs 11 are formed at two ends of the tongue portion 12 respectively. They are also adjacent to the opening (not labeled) of two side passageways 103. Referring to FIG. 1 in detail, each side rib 11 is formed of two approximately cuboid parts 11A, 11B. The height of cuboid part 11B is larger than that of cuboid part 11A. And the cuboid parts 11B are located outer than the cuboid parts 11A respectively in a horizontal direction, that is to say, the two cuboid parts 11A are adjacent and opposite to each other. Each cuboid part 11A comprises a pair of horizontal first surfaces 110 and a vertical inside surface 112, and each cuboid part 11B comprises a pair of horizontal second surfaces 111 and an outside surface 114. The outside surface 114 is a little arc-shaped. The distal ends of each joint cuboid parts 11A and 11B are an integrated planar surface called outer surface 113. The tongue portion 12 comprises a pair of third surfaces 120. A mounting portion 13 is provided lower than the base portion 10, with a vertical portion 130 interconnecting a rear of the mounting portion 13 and a lower face (not labeled) of the base portion 10. The vertical slots 104 also extend through the vertical portion 130 and the mounting portion 13 to be exposed out of its bottom face. A channel 135 is defined in a middle of a front of the mounting portion 13 along a front-to-back direction to divide the mounting portion 13 into two guiding portions 137. An upper face of each guiding portion 137 respectively defines a depression portion 133 thereon. Two latching grooves 136 are defined on the edges of the bottom face of the mounting portion 13 respectively. A pair of columniform positioning posts 134 extend downwardly from the bottom face of the mounting portion 13.

In this embodiment, there are totally five terminals 2 which are approximately L-shaped and configured nearly the same. Each terminal 2 comprises a mating portion 20 extending forwardly for engaging with a contact of the complementary connector, and a vertical connecting portion 21 for connecting to a printed circuit board (PCB). Each horizontal mating portion 20 includes a first conductive surface 22, a second conductive surface 23 and an end surface 24. The first and second conductive surfaces 22, 23 of each terminal 20 are opposite to each other.

The electrical connector of present invention also includes a shell 3 with an approximately elliptic cross-section. A receiving space 31 is defined inside the shell 30 with an upper wall 35 and a lower wall 32 opposite to each other. A rear of the lower wall 32 defines a rectangular gap 33, the two sides 33′ of which respectively extends two pairs of plate-like mounting legs 38 vertically and a pair of latching legs 39 curved at their ends. A plate-like positioning leg 34 is provided apart from a front of the rectangular gap 33. Each upper and lower walls 35 and 32 form a pair of curved beams 36 extending forwardly with the distal ends bent inwardly into the receiving space 31. A rear of the upper wall 35 forms two spring tabs 37 extending downwardly and defectively into the receiving space 31.

Referring to FIGS. 1-3, in assembly, the horizontal mating portion 20 of each terminal 2 is firstly inserted into corresponding receiving passageway 103 of the base portion 10 from its rear into the tongue portion 12. The connecting portion 21 of each terminal 2 is received in corresponding vertical slot 104 and extends out of the bottom face of the mounting portion 13. Because side ribs 11 extend forwardly adjacent to the opening of the two side passageways 103 from the front face 101 of the base portion 10, each of the two outer terminals 2 lies with corresponding side rib 11 side by side. More specifically, a side surface (not labeled) of each outer terminal 2 touches with the inside surface 112 of corresponding side rib 11. In a vertical direction, the first and second conductive surfaces 22, 23 respectively protrude a little distance beyond corresponding first surfaces 110 of the side ribs 11, and the two second surfaces 111 respectively protrude a little distance beyond first and second conductive surfaces 22, 23. The two outer surfaces 113 of the ribs 11 protrude beyond the end surfaces 24 of the terminals 2, in other word, the ribs 11 extend further than the terminals 2 in a direction away from the base portion. The tongue portion 12 defines a through-hole 122 therein in communication with the middle passageway 103, and the middle terminal 2 is received in the middle passageway 103 and the through-hole 122. The first and second conductive surfaces 22, 23 of the middle terminals 2 respectively protrude a little distance beyond the corresponding third surfaces 120. The end surface 24 of the middle terminal 2 abuts against the inside face of the beam 121, and the side surface of each of the two neighboring ones 2 extend with the side surface being arranged on the side face of the parts of the tongue portion 12. The mating portions 20 of the terminals 2, the tongue portion 12 and the side ribs 11 extend the same direction, and are parallel with each other.

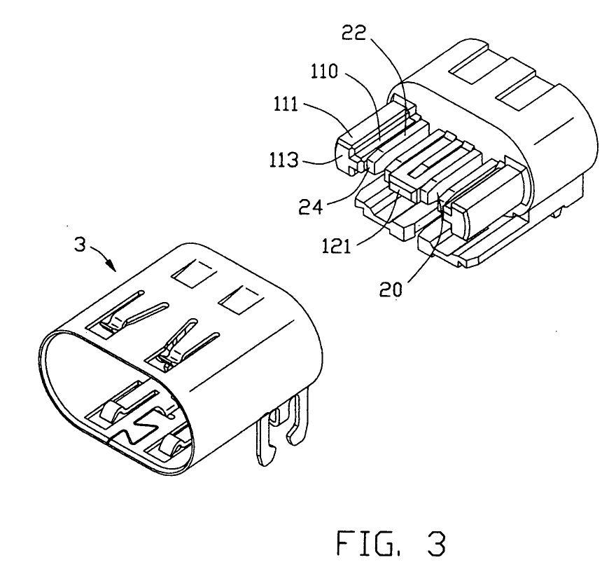

Referring to FIGS. 3-5, the shell 3 is assembled to the insulative housing 1. The insulative housing 1 is inserted into the receiving space 31 from the rear of the shell 3, with the positioning leg 34 abutting against an end of the channel 135 defined on the insulative housing 1. Then the two spring tabs 37 on the shell 3 abut against corresponding cutouts 106 defined on the base portion 10, the two curved beams 36 on the lower surface 36 of the shell 3 are located above corresponding depression portions 133 of the mounting portion 13, and the latching legs 39 clamp with corresponding latching grooves 136. The positioning post 134 is mounted to the PCB, and the positioning legs 34 and the mounting legs 38 are soldered to the PCB.

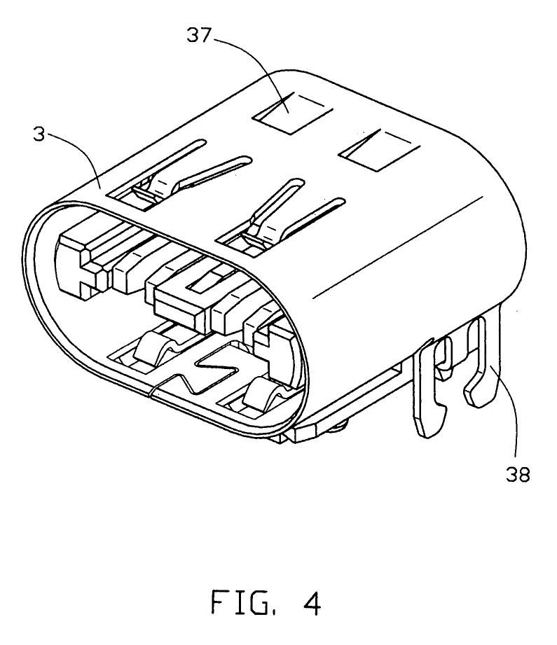

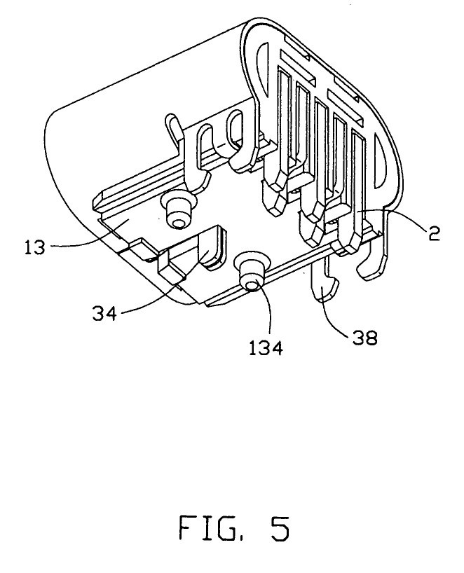

The complete configuration of this electrical connector is shown in FIG. 4 and FIG. 5. When the complementary connector is inserted, each curved beams 36 of the shell 3 having a distal end bent inwardly into the receiving space 31 imposes a clamping force to retain the complementary connector in the electrical connector. As the two second surfaces 111 of the side ribs 11 respectively protrude a little distance beyond corresponding first and second conductive surfaces 22, 23 of the terminals 2, when the insertion direction of the complementary connector deflects, especially upwards or downwards direction, force is applied to the side ribs 11 firstly, then leaving quite lighter force on the terminals 2. And it also weakens the horizontal-deflected force by the protruding of the distal surface (not labeled) of the tongue portion 12 and the outer surfaces 113 of the side ribs 11 beyond the end surfaces 24 of the terminals 2. Some terminals 2 extend adjacent the parts of the tongue portion 12, with the side surface of the terminal 2 being arranged on the side face of the parts of the tongue portion 12, which is effectively acting in avoiding these terminals 2 being knocked to bent in directions toward the parts of the tongue portion 12. All these structures can protect the electrical connector from damages by deflective insertion of the complementary connector, which would lead the terminals 2 to be knocked to warp.

The electrical connector of this invention forms protruding ribs 11 at the side of the terminals 2. And the ribs 11 are provided in the interior of the base portion 10, which would not enlarge the size of the connector. The ribs 11 can be configured as other shapes, while each rib 11 has a pair of opposite surfaces protruding beyond the conductive surfaces of the terminals 2, and it is provided longer than the terminals 2 extending from the front face 101. Each of the terminals 2 has two conductive surface exposed in the air, which is good for radiating the heat resulting from the transmitting of the electrical signals. The tongue portion 12 of this connector is approximately plate-like, so it is convenient for manufacture.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. An electrical connector comprising:
an insulative housing comprising a base portion defining a plurality of passageways extending therethrough, a tongue portion extending forwardly from the base portion, and a rib formed at an end of the tongue portion; and
a plurality of terminals received in the passageways and extending forwardly for dividing the tongue portion into several parts, each of the terminals comprising a conductive surface, the rib extending adjacent to one of the terminals and partially protruding beyond the conductive surface of the one of the terminals.

2. The electrical connector as described in claim 1, wherein each of the terminals comprises opposite first and second conductive surfaces, the rib comprises a pair of surfaces respectively protruding beyond the first and second conductive surfaces of the one of the terminals.

3. The electrical connector as described in claim 2, wherein the rib comprises a first part and a second part, and the second part is located outer than the first part in a horizontal direction.

4. The electrical connector as described in claim 3, wherein the one of the terminals extends adjacent the first part of the rib.

5. The electrical connector as described in claim 4, wherein the first part of the rib comprises a pair of opposite first surfaces, the second part of the rib comprises a pair of opposite second surfaces, and the second surfaces protrude beyond the first surfaces respectively in a vertical direction.

6. The electrical connector as described in claim 5, wherein the first and the second conductive surfaces of the terminals protrude beyond the first surfaces of the first part respectively in a vertical direction.

7. The electrical connector as described in claim 6, wherein the second surfaces of the second part protrude beyond the first and the second conductive surfaces of the terminals respectively in a vertical direction.

8. The electrical connector as described in claim 1, wherein the parts of the rib lie parallel with each other in a mating direction.

9. The electrical connector as described in claim 8, wherein two neighboring divided parts of the rib are linked by a beam at distal ends thereof and define a through-hole therebetween in communication with one of the passageways to receive one of the terminals therein.

10. The electrical connector as described in claim 1, wherein the rib extends further than the terminals in a direction away from the base portion.

11. The electrical connector as described in claim 1, further comprising a shell of an elliptic cross-section surrounding the insulative housing.

12. The electrical connector as described in claim 1, wherein a mounting portion is provided lower than and connecting to the base portion, and the mounting portion extends parallel with the tongue portion.

13. An electrical connector comprising:
an insulative housing including a base defining a lengthwise direction, a vertical direction and a mating direction perpendicular to one another;
a metallic shell enclosing the housing and defining therein a receiving cavity in front of the base;
a plurality of juxtaposed contacts disposed in the housing with corresponding contacting sections extending beyond the base and into the receiving cavity along said mating direction; and
a pair of supporting ribs extending from the base in said mating direction and respectively abutting against two outer sides of a pair of contacting sections in said lengthwise direction while a space between said pair of contacting sections being essentially empty for receiving a mating portion of a complementary connector.

14. The electrical connector as claimed in claim 13, wherein said rib extends beyond the corresponding contacting section in said mating direction for protection during mating.

15. The electrical connector as claimed in claim 13, wherein said rib extends above the corresponding contacting section in said vertical direction for protection during mating.

16. The electrical connector as claimed in claim 15, wherein a portion of said rib which abuts against the corresponding contacting section is thinned to be lower than the corresponding contacting section for electrical and mechanical connection between said corresponding contacting section and a mating terminal of the complementary connector.

17. The electrical connector as claimed in claim 13, wherein each of said contacting sections defines opposite upper and lower sides, which is perpendicular to the corresponding outer side and is exposed for mating a mating terminal of the complementary connector.

18. The electrical connector as claimed in claim 13, further including another contacting sections symmetrically arranged in the housing with said pair of contacting sections, and cooperating with another supporting ribs in a same manner with said pair of contacting sections.

19. The electrical connector as claimed in claim 18, further including another contacting section supportably abutted against by two of said pair of supporting ribs and said another pair of supporting ribs on two side of said another contacting section in said lengthwise direction.

20. An electrical connector comprising:
an insulative housing having a base with a bottom plate extending forwardly from a bottom edge of said base;
a slot extending rearwardly into the bottom plate from a front edge of said bottom plate, said slot extending through said bottom plate in a vertical direction;
a plurality of contacts disposed in the housing and including a plurality of contacting sections extending forwardly beyond the base above said bottom plate;
at least one support rib extending forwardly from the base above said bottom plate and supporting at least one of said contacting section; and
a metallic shell enclosing said contacting sections and said support rib while without said bottom plate; wherein
said metallic shell includes a mounting leg extending downwardly to extend through said slot.
